(19) United States
(12) Patent Application Publication
(10) Pub. No.: US 2024/0391690 A1
(43) Pub. Date: Nov. 28, 2024

(54) STOCKER CRANE SYSTEM AND METHOD OF OPERATING THE SAME

(71) Applicant: LG ENERGY SOLUTION, LTD., Seoul (KR)

(72) Inventor: Jin Ho YOOK, Daejeon (KR)

(73) Assignee: LG ENERGY SOLUTION, LTD., Seoul (KR)

(21) Appl. No.: 18/694,611

(22) PCT Filed: Sep. 27, 2022
(86) PCT No.: PCT/KR2022/014468

§ 371 Date: Mar. 22, 2024

(30) Foreign Application Priority Data
Oct. 1, 2021 (KR) 10-2021-0130841

(51) Int. Cl. B65G 1/04; B66F 9/07; B66F 9/075

(52) U.S. Cl. CPC B65G 1/0421; B66F 9/07; B66F 9/0755

(57) ABSTRACT

A stocker crane includes a drive motor configured to operate a wheel, a motor encoder connected to the drive motor, an external encoder connected to a timing belt, and a controller connected to the drive motor, the motor encoder, and the external encoder, in which the controller is configured to instruct the drive motor to move a position of the stocker crane, identify a command position based on information on a first rotational speed received from the motor encoder, identify a movement position based on information on a second rotational speed received from the external encoder, and control an operation of the drive motor based on a deviation between the command position and the movement position. A method of operating a stocker crane is also provided.

### CROSS-REFERENCE TO RELATED APPLICATION

This application claims priority to and the benefit of Korean Patent Application No. 10-2021-0130841 filed in the Korean Intellectual Property Office on Oct. 1, 2021, the entire contents of which are incorporated herein by reference.

### TECHNICAL FIELD

Embodiments disclosed herein relate to a stocker crane system and management thereof.

### BACKGROUND ART

In the case of an automatic warehouse system that is expanded and applied in a logistics automation field, a stocker crane system is used to move an article or a workpiece to a rack for a freight shelf in a factory or a warehouse. For example, the stocker crane system may be used for a process of activating a secondary battery. First, a tray (or carriage) for an inspection target is loaded to an inspection position by a stocker crane, a charging/discharging device is connected to the inspection target, and then an activation process of charging/discharging a battery pack provided in the tray is performed. When the activation process is completed, the tray is unloaded by the stocker crane, and the above-mentioned processes are repeatedly performed until the activation process is completely performed on all the trays for the inspection targets. In this case, the stocker crane may have a structure capable of loading or unloading the plurality of trays and simultaneously move the plurality of trays, which makes it possible to improve efficiency.

### DISCLOSURE

### Technical Problem

When a motor operates to operate a wheel of the stocker crane, the stocker crane system may identify a position of the stocker crane by using a motor encoder attached to a motor and an external encoder disposed outside the motor. For example, the external encoder is connected to a pulley and rotates by means of a timing belt, and the stocker crane system may identify a rotation value of the external encoder. In addition, the stocker crane system may identify a rotation value of the motor encoder. However, in the case of the external encoder, the accuracy of the rotation value may deteriorate because of elastic deformation of a spring of the pulley. In the case of the motor encoder, the accuracy of the rotation value may deteriorate because of a slip of the wheel.

Technical problems of the embodiments disclosed in the present document are not limited to the aforementioned technical problems, and other technical problems, which are not mentioned above, may be clearly understood by those skilled in the art from the following descriptions.

### Technical Solution

A stocker crane disclosed in the present document may include: a drive motor configured to operate a wheel; a motor encoder connected to the drive motor; an external encoder connected to a timing belt; and a controller connected to the drive motor, the motor encoder, and the external encoder, in which the controller is configured to: instruct the drive motor to move a position of the stocker crane; identify a command position based on information on a first rotational speed received from the motor encoder; identify a movement position based on information on a second rotational speed received from the external encoder; and control an operation of the drive motor based on a deviation between the command position and the movement position.

A method of operating a stocker crane disclosed in the present document may include: instructing, by a controller, a drive motor to move a position of the stocker crane; identifying a command position based on information on a first rotational speed received from a motor encoder; identifying a movement position based on information on a second rotational speed received from an external encoder; and controlling an operation of the drive motor based on a deviation between the command position and the movement position.

### Advantageous Effects

The stocker crane system according to the embodiment disclosed in the present document may accurately determine the movement and stop positions of the stocker crane and control an error or deviation.

The stocker crane system according to the embodiment disclosed in the present document may prevent a collision with the stopper.

### DESCRIPTION OF DRAWINGS

FIG. 1 is a view illustrating a stocker crane system according to various embodiments.

FIG. 2 is a block diagram of the stocker crane according to various embodiments.

FIG. 3 is a view illustrating an example of a structure of the stocker crane and a structure of an external encoder.

FIG. 4 is an operational flowchart for controlling a drive motor according to various embodiments.

FIG. 5 is a view illustrating an operation pattern according to various embodiments.

FIG. 6 is an operational flowchart for controlling the drive motor according to various embodiments.

FIG. 7 is an operational flowchart for controlling the drive motor according to various embodiments.

### MODE FOR INVENTION

Hereinafter, various embodiments disclosed in the present document will be described in detail with reference to the accompanying drawings. In the drawings of the present document, the same constituent elements will be designated by the same reference numerals, and the repetitive description of the same constituent elements will be omitted.

Specific structural or functional descriptions of various embodiments disclosed in the present document are exemplified only for the purpose of explaining the embodiments, the embodiments disclosed in the present document may be carried out in various forms, and it should not be interpreted that the present document is limited to the embodiments described in the present document.

The terms “first” and “second” used in various embodiments may be used regardless of the order and/or importance of various constituent elements and do not limit the corresponding constituent elements. For example, a first constituent element may be named a second constituent element, and similarly, the second constituent element may also be named the first constituent element, without departing from the scope of the embodiment disclosed in the present document.

The terms used in the present document are used to just describe a specific embodiment and do not intend to limit the scope of another embodiment. Singular expressions may include plural expressions unless clearly described as different meanings in the context.

All terms used herein, including technical or scientific terms, may have the same meaning as commonly understood by those skilled in the art to which the embodiments disclosed in the present document pertain. The terms such as those defined in a commonly used dictionary may be interpreted as having meanings identical or similar to meanings in the context of related technologies and should not be interpreted as ideal or excessively formal meanings unless explicitly defined in the present document. In some instances, the terms defined in the present document should not be interpreted to exclude the embodiments disclosed in the present document.

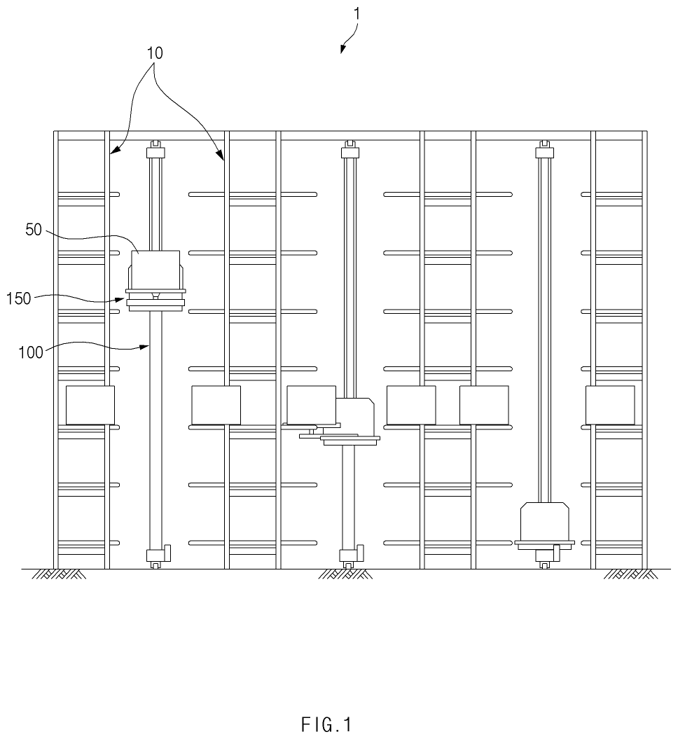

FIG. 1 is a view illustrating a stocker crane system 1 according to various embodiments. The stocker crane system 1 illustrated in FIG. 1 is provided for illustration only. The positions and shapes of the components are not limited to the example illustrated in FIG. 1.

Referring to FIG. 1, the stocker crane system 1 may include stocker cranes 100 configured to load articles 50 on racks 10 or unload the articles 50 from the racks 10. For example, the stocker crane 100 may place the article 50 on a carriage 150 and be positioned on a designated rack 10 by moving upward, downward, leftward, and rightward. The stocker crane 100 may use a fork and place the article 50 on the designated rack 10. On the same principle, the stocker crane 100 may use the fork and unload the article 50 placed on the rack 10.

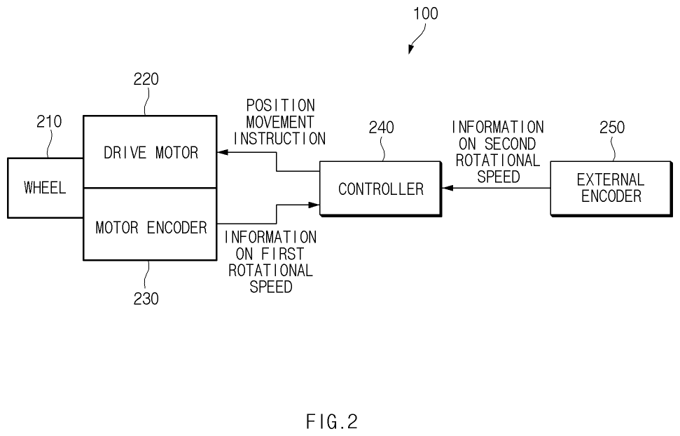

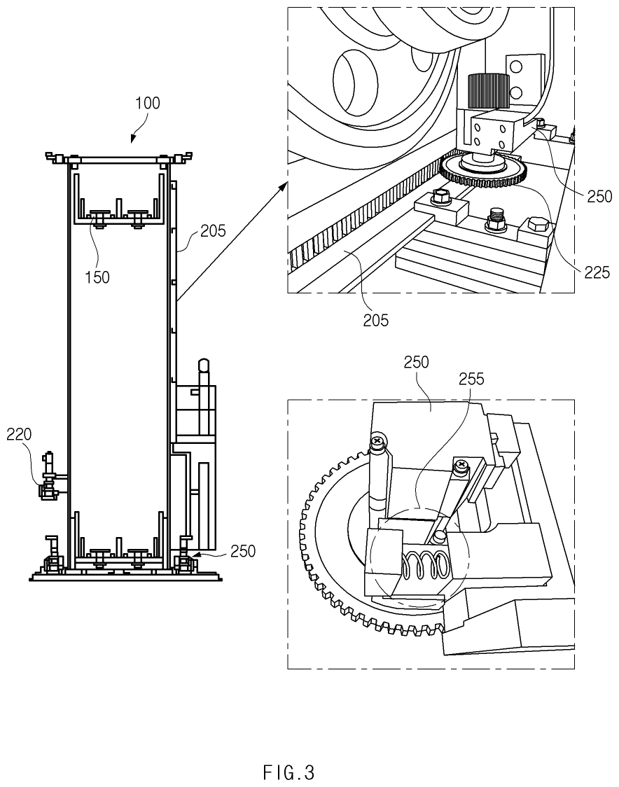

FIG. 2 is a block diagram of the stocker crane 100 according to various embodiments, and FIG. 3 is a view illustrating an example of a structure of the stocker crane 100 and a structure of the external encoder 250.

A drive motor 220 may operate a wheel 210 of the stocker crane 100 and move the stocker crane 100 or a component of the stocker crane 100. For example, as illustrated in FIG. 3, the drive motor 220 may operate to move the carriage 150 upward or downward. As another example, the stocker crane 100 may move on a flat rail in a designated direction by driving the wheel 210. For example, the drive motor 220 may be a servo motor.

The motor encoder 230 may be connected to the drive motor 220 to measure a rotational speed of the drive motor 220 or the wheel 210. For example, when the drive motor 220 operates the wheel 210 in response to a position movement instruction of the controller 240, the motor encoder 230 may measure the rotational speed of the drive motor 220 or the wheel 210 and transmit information on a measured first rotational speed to the controller 240.

The rotational speed measured by the motor encoder 230 may have an error caused by a slip of the wheel 210 or a problem with the resolution of the motor encoder 230. Therefore, to increase the positional accuracy, the stocker crane 100 may additionally use the external encoder 250. The external encoder 250 may be disposed outside the drive motor 220 and measure the position of the stocker crane 100. For example, referring to FIG. 3, the external encoder 250 may be connected to the pulley 225. When the timing belt 205 and the pulley 225 engage with each other, the pulley 225 may rotate while being connected to the timing belt 205. The external encoder 250 may determine the position of the stocker crane 100 (i.e., the movement position of the timing belt 205) on the basis of the rotation of the pulley 225. The external encoder 250 may transmit the information on a second rotational speed, which is measured by means of the pulley 225, to the controller 240. In this case, the external encoder 250 may include an elastic member 255 (e.g., a spring) having predetermined elasticity so that the engagement between the pulley 225 and the timing belt 205 may be accurately implemented. In the embodiment, the stocker crane 100 may use the information on the second rotational speed accessorily in addition to the information on the first rotational speed or use the information on the second rotational speed independently of the information on the first rotational speed.

For example, the controller 240 may include a servo driver or a servo amplifier. The controller 240 may be supplied power to rotate the drive motor 220. The controller 240 may adjust the rotation of the drive motor 220 by performing frequency modulation while serving as a converter or an inverter. The controller 240 may be connected to the respective components of the stocker crane 100 and control an overall operation of the stocker crane 100. For example, the controller 240 may transmit a movement instruction to the drive motor 220. In this case, the movement instruction may indicate a designated rotational speed. The drive motor 220 operates the wheel 210 in response to the movement instruction. When the stocker crane 100 moves, the controller 240 may identify a command position based on the information on the first rotational speed received from the motor encoder 230 and identify a movement position based on the information on the second rotational speed received from the external encoder 250. The ‘command position’ may mean a position of the stocker crane 100 that is determined on the basis of the rotational speed of the drive motor 220. The ‘movement position’ may mean a position of the stocker crane 100 that is determined on the basis of the position of the timing belt 205.

In the case of the movement position identified by means of the external encoder 250, the pulley 225 and the timing belt 205 may be separated or loosened because of elastic deformation of the elastic member 255. A collision accident may occur when an actual traveling position of the stocker crane 100 cannot be accurately calculated because of an error of the command position or the movement position. The controller 240 according to the embodiments may identify a deviation between the command position and the movement position and control the drive motor 220 to minimize the deviation. In this case, the controller 240 may control the rotational speed of the drive motor 220 on the basis of one of the command position and the movement position.

In addition, the controller 240 may control the drive motor 220 in consideration of a deviation between a current operation pattern determined on the basis of at least one of the command position or the movement position and a predicted operation pattern determined on the basis of repeated tests.

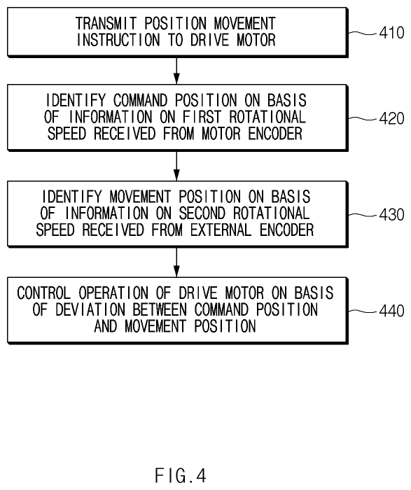

FIG. 4 is an operational flowchart for controlling the drive motor according to various embodiments. The operations described in the operational flowchart may be implemented by the stocker crane 100 or the constituent elements (e.g., the controller 240) of the stocker crane 100.

Referring to FIG. 4, in operation 410, the stocker crane 100 may transmit a position movement instruction to the drive motor 220.

In operation 420, the stocker crane 100 may identify the command position based on the information on the first rotational speed received from the motor encoder 230.

In operation 430, the stocker crane 100 may identify the movement position based on the information on the second rotational speed received from the external encoder 250.

In operation 440, the stocker crane 100 may control the operation of the drive motor 220 on the basis of the deviation between the command position and the movement position. For example, the stocker crane 100 may adjust the rotational speed of the drive motor 220 to reduce the deviation between the command position and the movement position. As an example, when the deviation between the command position and the movement position is equal to or higher than (or exceeds) a designated critical value, the stocker crane 100 may stop the operation of the drive motor 220.

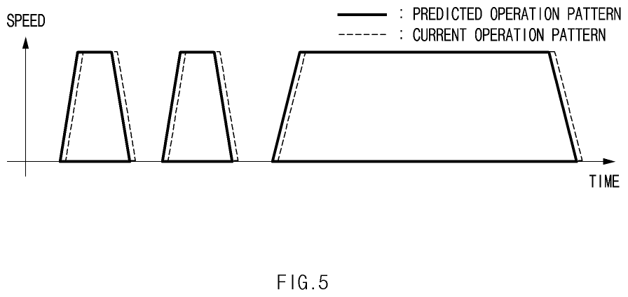

FIG. 5 is a view illustrating an operation pattern according to various embodiments.

Referring to FIG. 5, the graph illustrates an operation pattern of the stocker crane 100 with respect to the time (horizontal axis). The graph illustrated in FIG. 5 shows a speed over time, whereas the operation pattern may indicate the movement distance or acceleration. The stocker crane 100 may determine the operation pattern on the basis of at least one of the command position and the movement position. The predicted operation pattern may be a value predetermined by the repeated tests, and the predicted operation pattern may be stored as table information. When an error occurs on the command position or the movement position, a deviation occurs between the current operation pattern and the predicted operation pattern. The stocker crane 100 (or the controller 240) may stop the operation of the stocker crane 100 in order to ensure safety when the deviation between the current operation pattern and the predicted operation pattern is equal to or higher than (or exceeds) a designated critical value.

The deviation between the current operation pattern and the predicted operation pattern may be changed depending on the movement distance of the stocker crane 100. The deviation may become a maximum deviation when the stocker crane 100 moves a longest distance. Therefore, the stocker crane 100 may determine in advance a maximum deviation (i.e., a value made when the deviation is a maximum deviation) on the basis of the test. When the deviation between the current operation pattern and the predicted operation pattern is the maximum deviation, the controller may stop the operation of the stocker crane. On the same principle, the stocker crane 100 may determine in advance the maximum deviation between the command position and the movement position on the basis of the test. When the currently calculated deviation is the maximum deviation, the controller may stop the operation of the stocker crane.

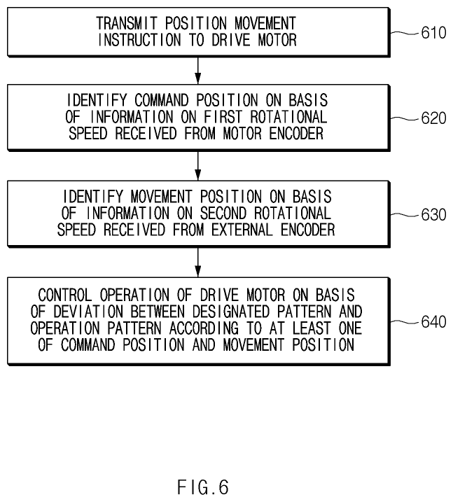

FIG. 6 is an operational flowchart for controlling the drive motor according to various embodiments. Because operations 610 to 630 illustrated in FIG. 6 are identical to operations 410 to 430 illustrated in FIG. 4, a description thereof will be omitted.

In operation 640, the stocker crane 100 may control the operation of the drive motor 220 on the basis of a deviation between a designated pattern and an operation pattern (i.e., a current operation pattern) according to at least one of the command position and the movement position. For example, the stocker crane 100 may stop the operation of the drive motor 220 when the deviation between the current operation pattern and the designated pattern is equal to or higher than the critical value (e.g., the maximum deviation). As another example, the stocker crane 100 may control the rotational speed of the drive motor 220 to reduce the deviation between the current operation pattern and the designated pattern.

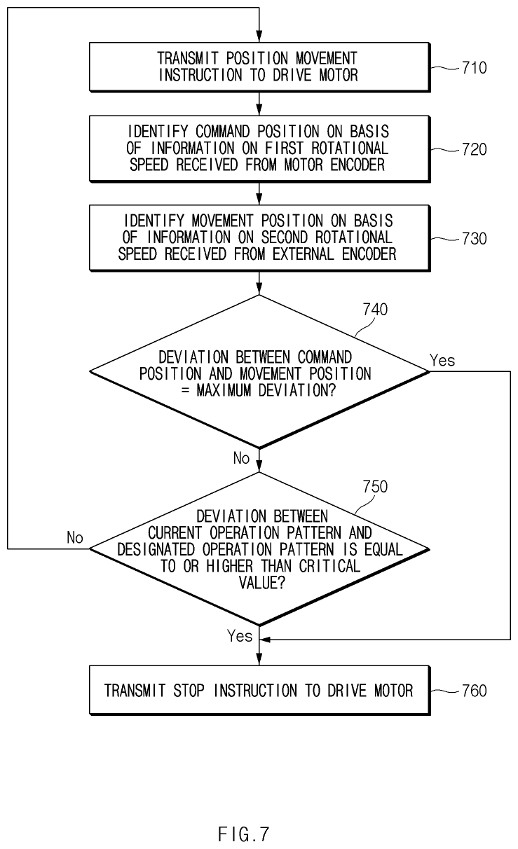

FIG. 7 is an operational flowchart for controlling the drive motor according to various embodiments. Because operations 710 to 730 illustrated in FIG. 7 are identical to operations 410 to 430 illustrated in FIG. 4, a description thereof will be omitted.

In operation 740, the stocker crane 100 may identify whether the deviation between the command position and the movement position is the maximum deviation (or the critical value). When the deviation reaches the maximum deviation, the controller 240 may transmit a stop instruction to the drive motor 220 in operation 760.

When the deviation is equal to or lower than the maximum deviation, the stocker crane 100, in operation 750, may identify whether the deviation between the current operation pattern and the designated operation pattern is equal to or higher than the critical value (e.g., the maximum deviation). The critical value, which is used to compare the operation patterns, may be a value identical to different from the critical value that is used to analyze the deviation between the command position and the movement position. When the deviation is equal to or higher than the critical value, the controller 240 may transmit a stop instruction to the drive motor 220 in operation 760. When the deviation is equal to or lower than the critical value, the stocker crane 100 may repeat operations 710 to 750.

All the constituent elements, which constitute the embodiment disclosed in the present document described above, may be integrally coupled or operate by being combined, but the embodiments disclosed in the present document are not necessarily limited to the embodiment. That is, one or more of the constituent elements may be selectively combined and operated within the object of the embodiments disclosed in the present document.

In addition, unless explicitly described to the contrary, the words “comprise,” “include,” or “have” and variations such as “comprises,” “comprising,” “includes,” “including,” has,” or “having,” should be understood to imply the inclusion of stated elements but not the exclusion of any other elements. Unless otherwise defined, all terms including technical or scientific terms may have the same meaning as commonly understood by those skilled in the art to which the embodiments disclosed in the present document pertain. The terms such as those defined in a commonly used dictionary may be interpreted as having meanings consistent with meanings in the context of related technologies and may not be interpreted as ideal or excessively formal meanings unless explicitly defined in the present document.

The above description is simply given for illustratively describing the technical spirit disclosed in the present embodiment, and those skilled in the art to which the embodiments disclosed in the present document pertain will appreciate that various changes and modifications are possible without departing from the essential characteristics of the embodiments disclosed in the present document. Therefore, the embodiments disclosed in the present document are provided for illustrative purposes only but not intended to limit the technical concept of the embodiments disclosed in the present document. The scope of the technical spirit disclosed in the present document is not limited by the embodiment. The protective scope of the technical spirit disclosed in the present document should be construed based on the appended claims, and all the technical spirit in the equivalent scope thereto should be construed as falling within the scope of the present document.

1. A stocker crane comprising:
a drive motor configured to operate a wheel;
a motor encoder connected to the drive motor;
an external encoder connected to a timing belt; and
a controller connected to the drive motor, the motor encoder, and the external encoder,
wherein the controller is configured to:
instruct the drive motor to move a position of the stocker crane;
identify a command position based on information on a first rotational speed received from the motor encoder;
identify a movement position based on information on a second rotational speed received from the external encoder; and
control an operation of the drive motor based on a deviation between the command position and the movement position.

2. The stocker crane of claim 1, wherein the controller is further configured to control the operation of the drive motor based on a deviation between a designated pattern and an operation pattern according to at least one of the command position and the movement position.

3. The stocker crane of claim 2, wherein the controller is further configured to stop the operation of the drive motor when the deviation between the operation pattern and the designated pattern is equal to or higher than a first critical value or the deviation between the command position and the movement position is equal to or higher than a maximum deviation.

4. The stocker crane of claim 2, wherein the operation pattern and the designated pattern each indicate at least one of a movement distance, a time, a speed, or an acceleration of the stocker crane.

5. The stocker crane of claim 4, wherein the operation pattern and the designated pattern each further indicate at least one of the time, the speed, or the acceleration according to a maximum movement distance of the stocker crane.

6. A method of operating a stocker crane, the method comprising:
instructing, by a controller, a drive motor to move a position of the stocker crane;
identifying a command position based on information on a first rotational speed received from a motor encoder;
identifying a movement position based on information on a second rotational speed received from an external encoder; and
controlling an operation of the drive motor based on a deviation between the command position and the movement position.

7. The method of claim 6, further comprising controlling the operation of the drive motor based on a deviation between a designated pattern and an operation pattern according to at least one of the command position and the movement position.

8. The method of claim 7, wherein the controlling of the operation of the drive motor comprises stopping the operation of the drive motor when the deviation between the operation pattern and the designated pattern is equal to or higher than a first critical value or the deviation between the command position and the movement position is equal to or higher than a maximum deviation.

9. The method of claim 7, wherein the operation pattern and the designated pattern each indicate at least one of a movement distance, a time, a speed, or an acceleration of the stocker crane.

10. The method of claim 9, wherein the operation pattern and the designated pattern each further indicate at least one of the time, the speed, or the acceleration according to a maximum movement distance of the stocker crane.
